(19) United States
(12) Patent Application Publication
(10) Pub. No.: US 2013/0085870 A1
(43) Pub. Date: Apr. 4, 2013

(54) METHODS AND APPARATUS FOR SECURE AND ENHANCED CLASSIFIED LISTING SERVICES AND TRANSACTIONS

(71) Applicant: Joshua Seah, San Jose, CA (US)

(72) Inventor: Joshua Seah, San Jose, CA (US)

(21) Appl. No.: 13/633,447

(22) Filed: Oct. 2, 2012

Related U.S. Application Data
(60) Provisional application No. 61/543,308, filed on Oct. 4, 2011.

(51) Int. Cl. G06Q 30/02

(52) U.S. Cl. 705/14.72

(57) ABSTRACT

An enhanced classified listing service is provided to allow connections and transactions in classified listing services to occur in a more secure, informed, and codified manner. Online classified listings can be created, managed, and converted into customizable physical or electronic business cards with links, reputation data, contact information, and/or profile information, etc. Credible reputations can be built through recommendations, testimonials, and feedback from separate sources and information about reputations can be included on these physical or electronic business cards. A variety of enhancements improve classified listing services for parties involved in classified listing transactions.

### CROSS REFERENCE TO RELATED APPLICATIONS

The present invention claims priority of Provisional U.S. Application No. 61/543,308 filed Oct. 4, 2011, titled METHODS AND APPARATUS FOR SECURE AND ENHANCED CLASSIFIED LISTING SERVICES AND TRANSACTIONS by Joshua Seah (Attorney Docket No. YLNKP001P), the entirety of which is incorporated herein by reference.

### TECHNICAL FIELD

The present disclosure relates to secure and enhanced classified listing services and transactions.

### DESCRIPTION OF RELATED ART

Conventional classified listing services allow sellers and providers to connect with buyers and clients in a simple and low cost manner. Some websites and newspapers will charge a listings fee while others will not. Although conventional classified listing services have proved to be very successfully in facilitating transactions and connecting sellers and providers to buyers and clients, conventional classified listing services have a number of limitations.

Many conventional classified listing services are completely anonymous. Because the person on the other side of the transaction is anonymous, has an unverified identity, and/or has no independently confirmed reputation, transactions can be unsafe both physically and financially. There have been instances of significant criminal activity associated with classified listing services and connections made through classified listing services. Furthermore, there is no guarantee that the person on the other side of the transaction will follow through with agreed upon exchange terms. The agreed upon exchange terms may not even be fully known or understood. In many instances, exchange terms are unknown or codified only in informal messages and conversations. Sellers may say one thing and do another and buyers may have no recourse or ability to enforce agreed upon terms.

Profile information about particular classified listing users is either non-existent or extremely limited. Feedback is typically unverified and can lead to a sense of insecurity when conducting transactions using classified listing services.

Furthermore, classified listing themselves may become stale, and buyers will often have to sift through numerous items without knowing whether any particular stale listing is still active or a particular item is still available. Sellers often do not update posts even after a sale has been made. Stale listings also fall out of view, requiring sellers and providers to spend time reposting or relisting items that have not sold, yet it provides sellers with little motivation to remove listings for items that have already sold.

Conventional classified listing services also provide few mechanisms for a seller or provider to physically advertise or promote themselves in a manner easily linkable to actual classified listings. Physically advertisements are typically separate and disconnected from online classified listings. Information cannot be conveyed easily from one mechanism to another. Information transfer and integration remains disjointed and inefficient. Options for transferring limited information are also unavailable.

Consequently, techniques and mechanisms are provided for enhancing and securing processes and transactions associated with classified listings.

### BRIEF DESCRIPTION OF THE DRAWINGS

The disclosure may best be understood by reference to the following description taken in conjunction with the accompanying drawings, which illustrate particular embodiments.

FIG. 1 illustrates one example of a technique for converting a classified listing to a card such as a “YapCard” in physical or electronic format.

FIG. 2 illustrates one example of a simulated card or simulated “YapCard.”

FIG. 3 illustrates one example of a technique for creating a card.

FIG. 4 illustrates one example of a mechanism for customizing cards.

FIG. 5 illustrates one example of a mechanism for sending an electronic card.

FIG. 6 illustrates a mechanism for performing card management.

FIG. 7 illustrates one example of a system that can be used to implement various embodiments of the present invention.

### DESCRIPTION OF EXAMPLE EMBODIMENTS

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, the techniques of the present invention will be described in the context of particular processes and operations. However, it should be noted that the techniques of the present invention apply to a variety of processes and operations. In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors can while remaining within the scope of the present invention unless otherwise noted. Furthermore, the techniques and mechanisms of the present invention will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

Overview

An enhanced classified listing service is provided to allow connections and transactions in classified listing services to occur in a more secure, informed, and codified manner. Online classified listings can be created, managed, and converted into customizable physical or electronic business cards with links, reputation data, contact information, and/or profile information, etc. Credible reputations can be built through recommendations, testimonials, and feedback from separate sources and information about reputations can be included on these physical or electronic business cards. A variety of enhancements improve classified listing services for parties involved in classified listing transactions.

In various embodiments, connections and transactions between parties such as buyers and sellers, service providers and clients, job seekers and employers, etc., can be facilitated, enhanced, and secured. Communications including email messages, short message services, comments, etc., are maintained and codified into a contractual type document that can operate as a completion and/or acceptance document.

### Example Embodiments

Conventional classified listing services have a variety of drawbacks. Classified listing services typically do not allow reputation building through a variety of sources including friends and family testimonials, customer and client feedback, and fellow classified listing user recommendations. Without reputation information or access to sufficient profile information, conducting transactions can entail significant financial and physical risk to any party involved. Anonymity can be desirable in certain circumstances, but can also lead to unrestrained and undesirable conduct. Limited feedback may be available but may not necessarily be reliable. Physical risk can result from eventual connections with relatively anonymous individuals.

Aside from physical risks, there may also be financial risks and inefficiencies as transactions terms are not codified. Buyers and/or sellers may not follow through with agreed upon terms. There are limited mechanisms for generating a classified listing contract between the buyer and the seller. According to various embodiments, a seller, provider, or classified listing service member and a user, customer, or client can communicate via system email without revealing personal contact information. Acceptance of particular actions or messages may reveal additional profile information associated with the seller or buyer. In some instances, feedback, recommendations, and testimonials are also revealed as additional actions or messages are accepted. Emails, text messages, and even transcribed voice message transcripts can be codified into a contractual type document that may act as an acceptance document that allows a member to accept or decline a particular action or message. The contractual type document can also act as a completion document that allows a member to complete or cancel accepted actions or messages.

Job seekers and employers can connect not only in an informational manner, but reputation information including feedback, testimonials, and recommendations can be identified and evaluated in classified listings. According to various embodiments, reputation information for companies, contractors, non-profit agencies, individual employees, etc., can be determined based on information provided in classified listings. The information allows for deeper evaluation of candidates and employers prior to actual connections or interviews.

In particular embodiments, each classified listing item can also be converted into a physical business card and/or an electronic business card. Both the physical business card and the electronic business card allow individuals to see reputation and rating information associated with a particular listing or individual. In particular embodiments, both the physical business card and the electronic business can be automatically generated with web address information and/or links that allow anyone to obtain access to classified listing information, profile information, feedback, testimonials, and recommendations.

A physical or electronic business card may be generated and automatically sent to members or interested parties. Cards may be formatted and customized using different templates selected by the sender. In some instances, the sender can select the size, shape, color scheme, pattern, font, spacing, etc., of a particular card. In other instances, a sender can have a system automatically select and customize a card based on the preferences of an intended receiver. For example, a system may select particular size, shape, color scheme, pattern, font, spacing, etc., of a particular card by evaluating user profile information including age, gender, education level, favorite colors, past purchases, etc. In some instances, receivers may specify a particular electronic format or physical format for a card. Receivers may also specify patterns and colors and preferred types of cards, such as whether they would prefer a physical or electronic card.

In some instances, types of cards can be selected based on receiver purchase history or prior transactions that may indicate what types of cards have been effective in the past. Cards may also be generated based on receiver group membership or demographic profile. A variety of mechanisms can be used to generate receiver customized physical and electronic cards.

A user/member may easily select what type of information to include in a physical business card or electronic business card. In some instances, a user may elect to include or hide contact number, address, e-mail, name, and/or statistical and profile information. The information can be automatically acquired and generated into a physical or electronic card. Statistical and profile information may include reputation information.

Reputations can be built using a unique combination of self-generated profile information, feedback information from transaction partners, testimonials from friends and family, and recommendations from other classified listing service members. According to various embodiments, feedback information may include ratings that are awarded based on classified listing transaction experiences. For instance, a seller may receive feedback and a positive rating from a satisfied buyer. Testimonials are another reputation building mechanism and may be provided by third parties including family and friends. Recommendations may also be provided by fellow classified listing service members. In particular embodiments, recommendations can only be provided by fellow registered classified listing service members.

In particular embodiments, classified listing may provide support for a non-profit, assistance for an event, or aid to an individual or group by specifying a percentage donation from the classified listing service provider that will serve as proceeds to the non-profit or other entity.

To prevent classified listings from becoming stale, a boost feature is provided to place a particular classified listing at the top of the list without having to recreate a new posting. In some examples, users are limited to a particular number of boosts in a particular time frame. In particular embodiments, the time required between each boost remains the same. In other embodiments, the time required between successive boosts of a particular item increases with the number of times the item has been boosted in the past. According to various embodiments, any new feedback for a particular user will boost associated classified listings to the top of a listing, providing users with the ability to determine which users and/or associated listings have the most recent reputation activity.

The accompanying figures provide detail about individual transaction flows and are illustrative of various embodiments of the present invention. According to various embodiments, a technique for dynamically generating a physical or virtual/electronic card is illustrated. In particular embodiments, a user selects a classified listing for conversion into a physical or virtual/electronic card. The user then customizes data fields that will be shown on the face of the card. According to various embodiments, a system automatically translates the listing into data arranged within a predefined card template according to the member's custom specifications. In particular embodiments, the card includes a link to the user's classified listing.

In particular embodiments, the member can print a physical card using any printing device to create physical cards that can be provided to contacts, clients, and customers. The link information on the card can be used to access the member's online profile and classified listing details. In other embodiments, the member may generate a virtual card that is transmitted by email to a variety of contacts, clients, and customers. The virtual card can be used to view listing information or to access a link directly from a variety of different computing devices to view the member's online profile and classified listing details.

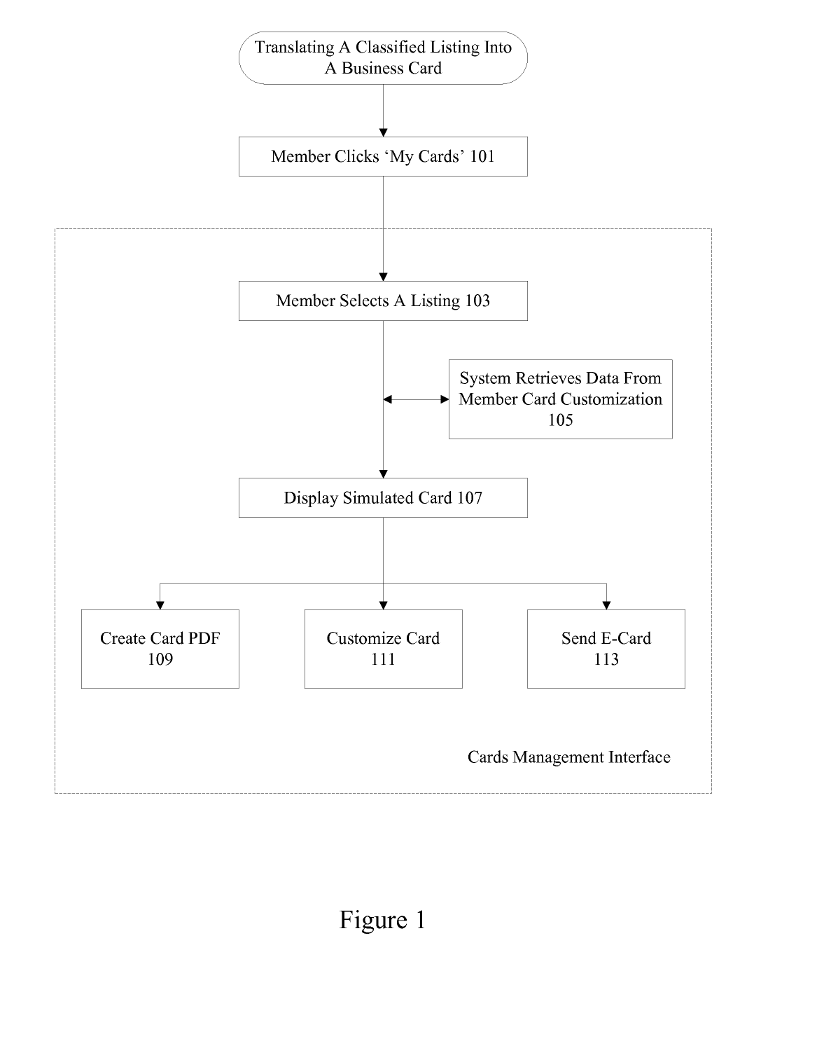

FIG. 1 illustrates one example for converting a classified listing to a card such as a “YapCard” in physical or electronic format. According to various embodiments, a user selects the “My YapCards” option or an option to create a card at 101. The user can then select a listing at 103. The listing may correspond to a service listing, a product listing, a coupon, an offer, business information, etc. According to various embodiments, a listing system retrieves data from user customization at 105. In some examples, the system may retrieve a template preselected by the user. In other examples, the system may generate a template based on other user information, such as type of business or type of product. In some instances, the system may generate a template based on potential customer or target customer information.

At 107, a simulated card is displayed. The simulated card may be displayed on a mobile device screen, computer system display screen, project display, etc. In particular exemplary embodiments, a user can elect to create a card such as a portfolio document format (PDF) card at 109. Cards may also be created in other formats such as image, vector, text, and hybrid formats. Cards may be printed or sent to another entity for printing. A user can also elect to customize a card at 111. Customizing a card may entail adjusting card text contents, modifying card layout, hiding or displaying certain types of information, changing designs, etc. A user can also elect to send an electronic card at 113. Electronic cards may similarly be provided in a variety of different formats such as PDF, image, vector, text, Vcard, and hybrid formats. Each physical and electronic card may include not only product, service, and provider information, but may also include links to the actual classified listing. An electronic card may include a clickable link to an actual classified listings page.

In other examples, the physical or electronic card can include quick response (QR) codes that can be scanned to immediately identity a product or service listing. The QR codes may launch an application or retrieve information about a provider or a particular classified listing. In other examples, bar codes, identification codes, etc., can also be provided on an automatically generated card. In some examples, a default card can be immediately generated simply by selecting a particular listing. The card can be used by sellers and buyers to more easily reference a product, offer, or service. In some examples, YapCoupons may be provided on the same document as a YapCard or on a completely separate entity. QR codes may be provided separately or on the same card.

In some examples, the card can include a coupon or coupon code that provides incentives for potential buyers to access the product listing or service. The coupon or coupon code may be general or targeted at a particular user and only available to the particular user. Coupon codes may also have time limitations and may be applicable to not only a particular classified listing, but multiple products and services from the same provider.

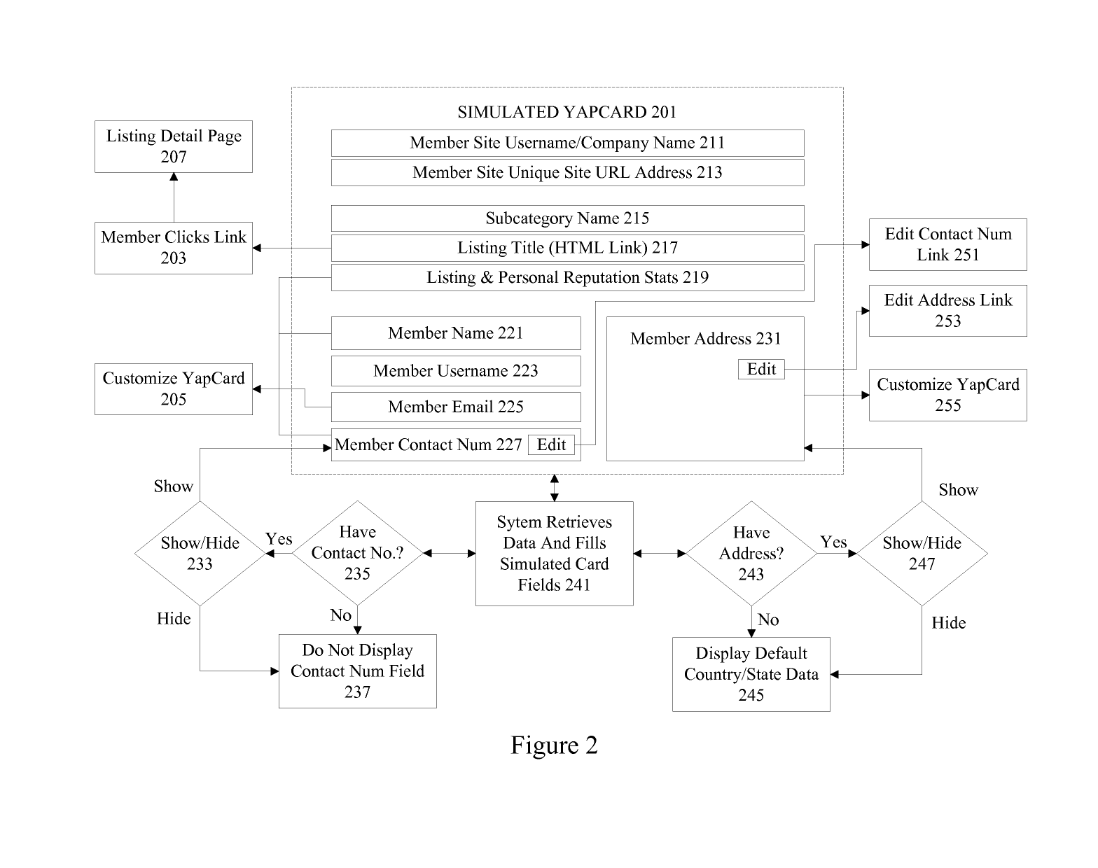

FIG. 2 illustrates one example of a simulated card or simulated “YapCard.” The card 201 may include information such as a username/company name 211, site URL address 213, a subcategory name 215, a listing title 217, and listing and personal reputation statistics 219. The card 201 may also include information such as a member name 221, member username 223, member email 225, and member contact number information 227. A member address 231 may also be included. According to various embodiments, a user has a tremendous amount of flexibility in easily selecting toggles to include only particular fields on a card 201. For example, the system may retrieve data and fill card fields at 241. The system may or may not have a contact number at 235. If the system does not have a contact number, the contact number field is not displayed at 237. Alternatively, if the user elects to hide the contact number field at 233, the contact number field is not displayed at 237.

In the same manner, the system may or may not have an address at 243. If the system does not have an address, default country and state data may be displayed at 245. Alternatively, if the user elects to hide the address field at 247, no address data is displayed and instead default country/state data may be shown at 245.

The card 201 may be an electronic or physical card. The card may have fields that can be edited such as a contact number at 251, address 253, or card customization 255 and 205. The card may also have a selectable listing title 217 such that a user can select a link at 203 to launch a listing detail page 207.

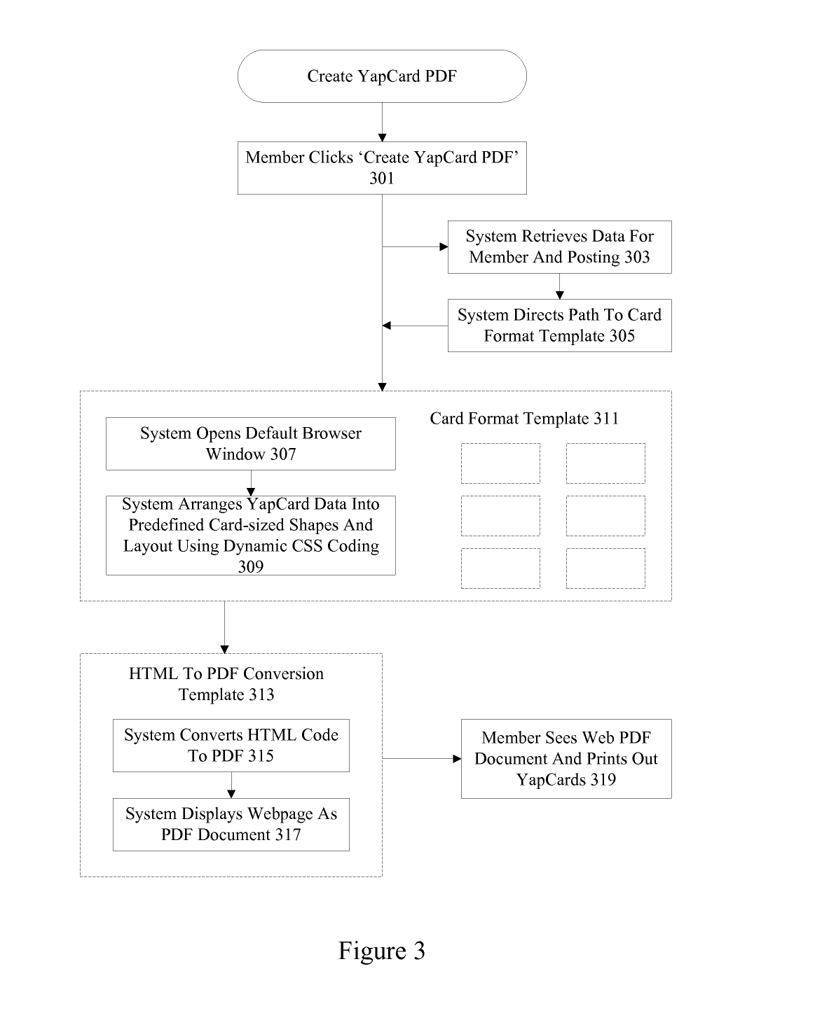

FIG. 3 illustrates one example of a technique for creating a card. According to various embodiments, a portable document format (PDF) card is created that can be easily printed and distributed. In particular exemplary embodiments, a user selects a create card PDF link at 301. The card generation system retrieves data for a user and/or a posting at 303. The system then retrieves card format template at 305.

According to various embodiments, a system opens a default browser window at 307 with a card format template at 311. The system arranges card data into predefined card-size shapes and layouts using dynamic cascading style sheets (CSS) Coding at 309. In particular exemplary embodiments, multiple card templates are loaded with user and/or listing information. At 313, HTML to PDF conversion occurs and the system converts HTML code to PDF data at 315. According to various embodiments, the system displays a webpage as a PDF document at 317. According to various embodiments, the member sees a web PDF document and prints out cards at 319.

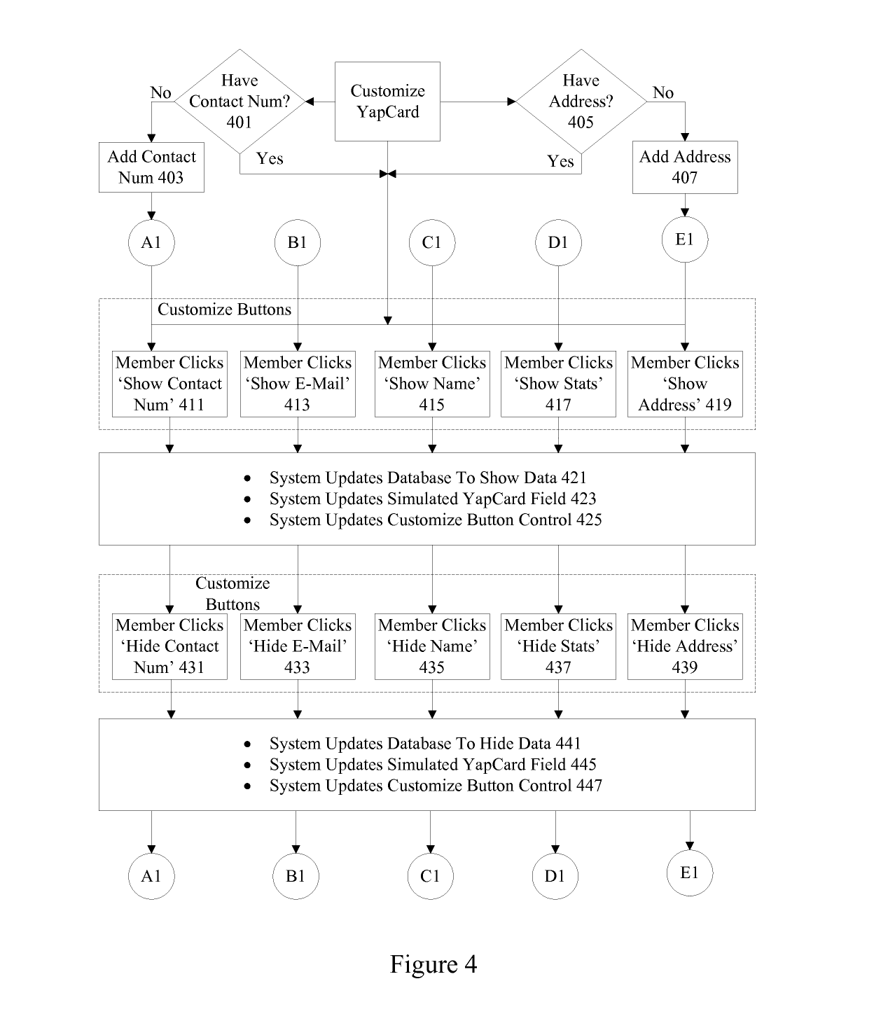

FIG. 4 illustrates one example of a mechanism for customizing cards. At 401, it is determined if a system has a contact number for a particular user. If not, a user adds a contact number at 403. At 405, it is determined if a system has address information. If not, a user adds address information at 407. According to various embodiments, a card generation mechanism provides customization buttons that allow a user to select whether particular fields are shown on a card. For example, a button A1 may allow a user to show a contact number at 411 on a card. A button B1 may allow a user to show an email address at 413 on the card. A button C1 may allow a user to show a name at 415 on the card. A button D1 allows a user to show statistics at 417 on the card. Statistics may include reputation information, feedback information, testimonial information, number of transactions completed, years using the service, etc. A button E1 may allow a user to show an address at 419 on the card. At 421, a system updates a database to show or hide particular fields of data. The system also updates a simulated card field at 423. According to various embodiments, a user may elect to show all information. According to various embodiments, the system updates customization button control at 425 as necessary based on selected toggles.

According to various embodiments, a member or user may elect to show less information. A member may elect to hide contact number information at 431, hide email information at 433, hide name information at 435, hide statistical information at 437, or hide address information at 439. Hide toggles for a particular field may only be shown when the particular field is displayed. The system updates the database to hide data at 441. The system updates a simulated YapCard field at 445. According to various embodiments, the system updates customize button control at 447 to reflect what fields may be shown or hidden.

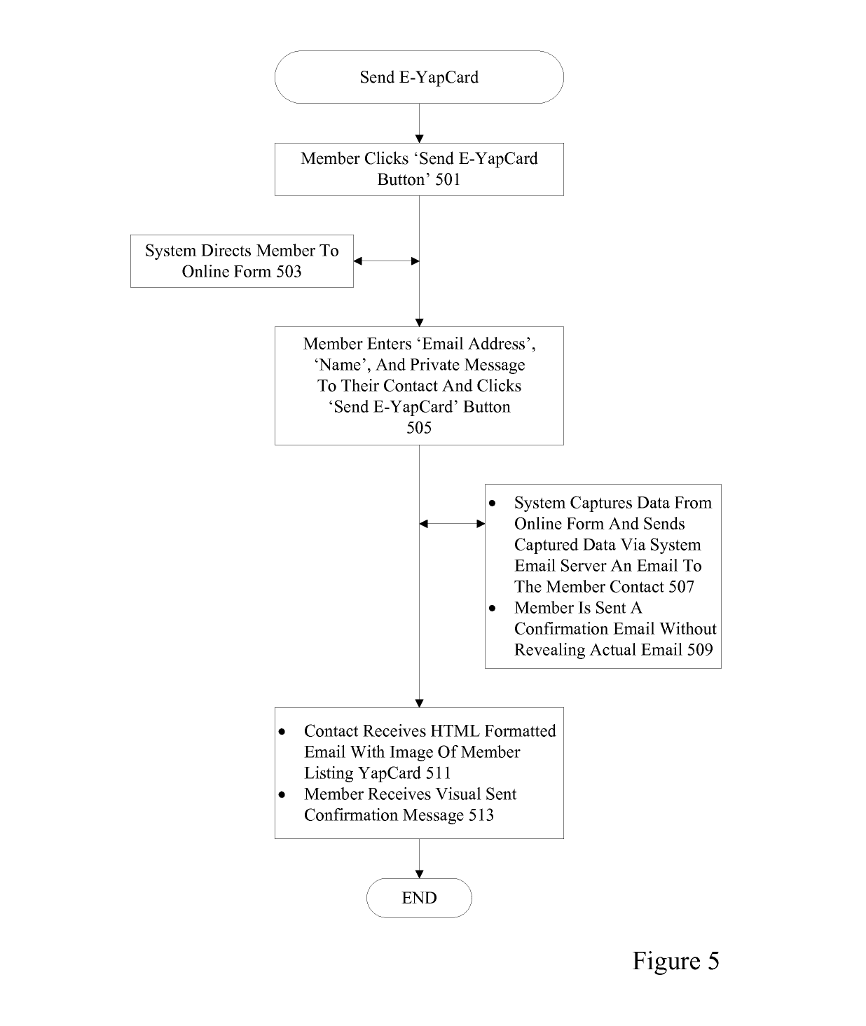

FIG. 5 illustrates one example of a mechanism for sending an electronic card. At 501, a member selects a send electronic card button. At 503, a system may direct the member to a particular online form at 503. According to various embodiments, the member enters an email address, a name, and a private message and clicks the send card button at 505. According to various embodiments, a card may be personalized by using information about a member or user. For example, a system may recognize that the recipient may enjoy outdoor activities or like the color green. A system may automatically adjust the color of the card to suit the recipient's interests. In other examples, the system may allow a user to select whether or not to customize the card based on the recipient's characteristics. In some instances, the system may provide additional details to the member about what the recipient likes and dislikes. The system may indicate that the recipient only purchases goods that have a discount applied. The electronic card may also provide a code to allow the recipient to receive a discount.

In other examples, some combination of member customizations and recipient customizations may be applied to create an electronic card. Recipients may also elect to hide certain personal information so that certain characteristics cannot be used to generate an electronic card. In some instances, recipients may not provide any information for use in customizing cards that they receive. At 507, a system captures data from the online form and sends captured data via system email to the recipient at 507. The member may be sent a confirmation email without revealing an actual email to the recipient at 509.

In particular exemplary embodiments, a recipient receives an HTML formatted email with an image of the member listing card at 511. The card may provide information about the member, a product/service listing, and offer, etc. A recipient can view the image of the card and select links to jump to a particular listing or the page of a particular member. The recipient may also elect to provide a card in PDF format. A member receives a visual sent confirmation message at 513.

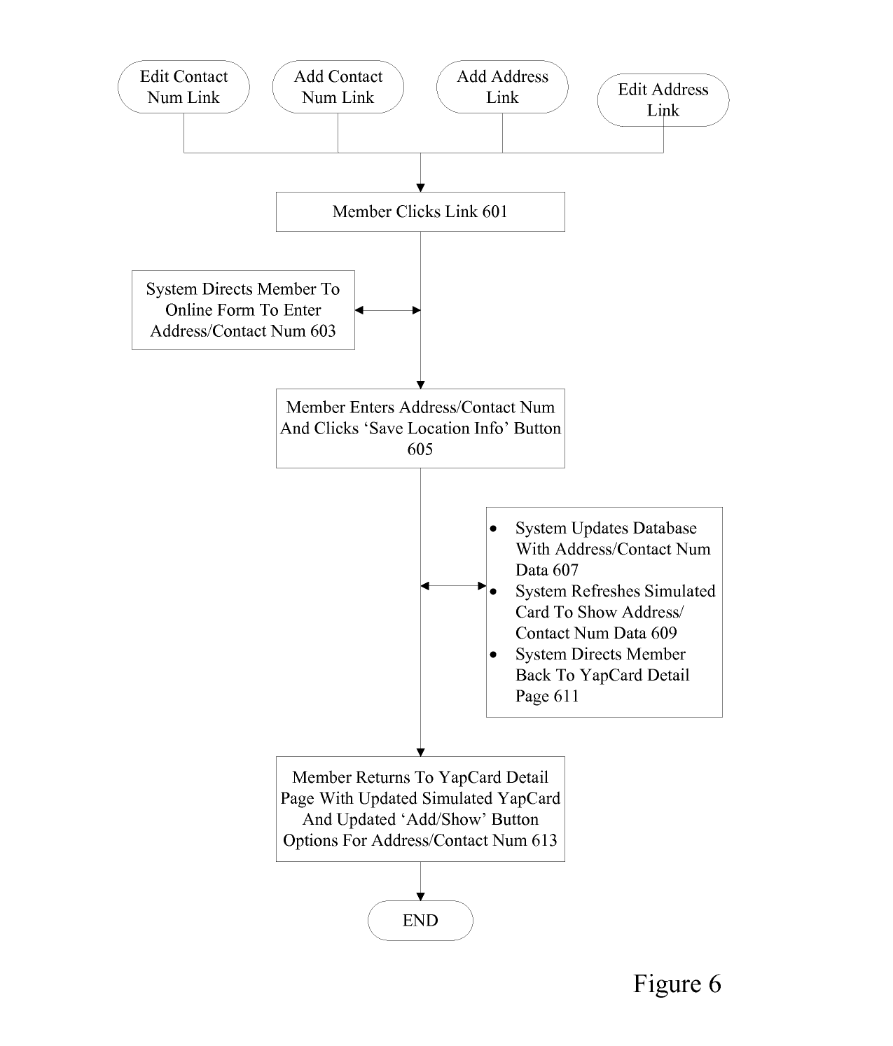

FIG. 6 illustrates another mechanism for performing card management. A member may edit a contact number, add a contact number, add an address, or edit and address. According to various embodiments, a member selects a link 601. In particular exemplary embodiments, the system directs the member to an online form to enter address/contact number information at 603. The member enters address/contact number information and clicks save location information at 605. The system updates the database with address/contact number data at 607. The system refreshes a simulated card to show address and contact number data at 609. At 611, the system directs a member back to a card detail page. A member returns to a card detail page with updated simulated card information and updated add/show button options for address/contact information at 613.

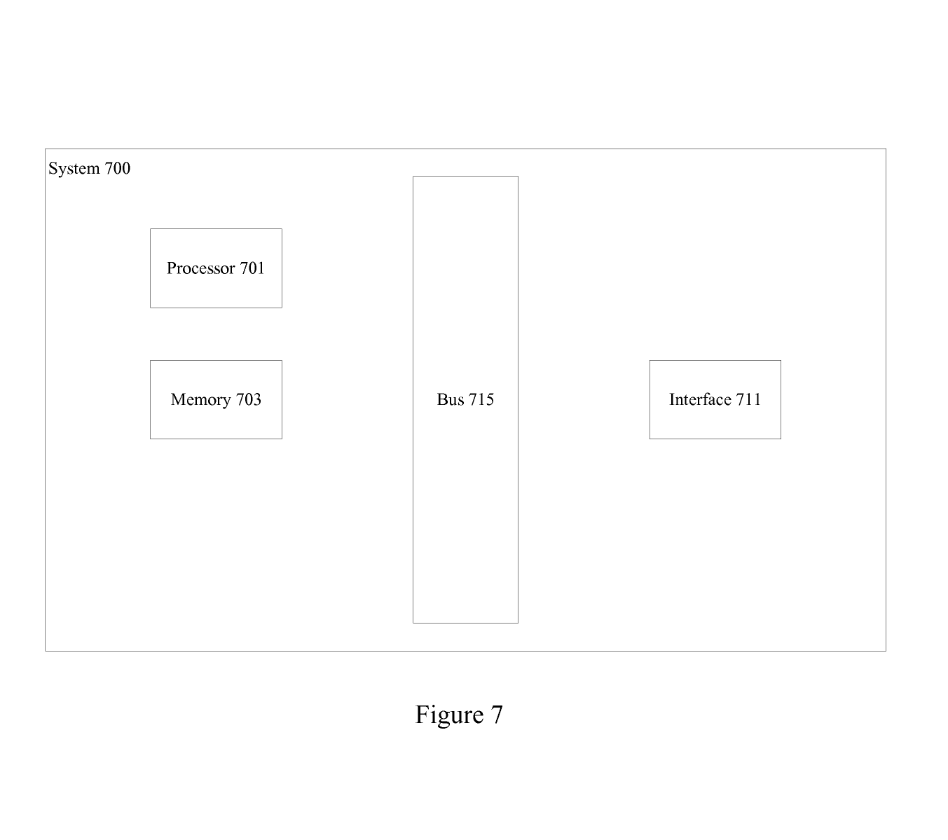

FIG. 7 illustrates one example of a system that can be used to implement various embodiments of the present invention. According to particular embodiments, a system 700 suitable for implementing particular embodiments of the present invention includes a processor 701, a memory 703, an interface 711, and a bus 715 (e.g., a PCI bus or other interconnection fabric) and operates as a streaming server. When acting under the control of appropriate software or firmware, the processor 701 is responsible for modifying and transmitting live media data to a client. Various specially configured devices can also be used in place of a processor 701 or in addition to processor 701. The interface 711 is typically configured to send and receive data packets or data segments over a network.

Particular examples of interface supports include Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management.

According to various embodiments, a technique for generating a contractual type document is also provided. In particular embodiments, the person searching for a particular listing or the searcher can communicate and start a contractual type secure communication (“Yap”). The individuals do not need to be members. In particular embodiments, a searcher completes an online form with contact information and reason for the contact. The form may be submitted to start an exchange or “Yap” with the member. In particular embodiments, the searcher or potential customer of the contact initiation receives email instructions to activate the exchange. The searcher can click on a link embedded within the activation email to activate the exchange. The action also creates a contractual type document which includes the exchange. The searcher may be directed to a unique web page that holds their secure contractual type document and may be asked to enter a password to login. The member will receive a notification that they have a new “Yap” once the searcher has clicked on the embedded link to activate the Yap. The member/lister receives notification that an exchange has been created by the searcher. The member/lister logs in to their account, selects the exchange (Yap), and enters the contractual type document.

In particular embodiments, the contractual type document allows a searcher that initiates the contact with the lister or person who lists a product or service. The searcher creates the Yap with the lister. The document allows a lister to accept or decline the searcher's exchange. The contractual type document acts as an acceptance document that allows the searcher to accept or decline the searcher's exchange. The contractual type document also operates as a completion document that allows the searcher to complete or cancel accepted exchanges. The lister is allowed to determine if the searcher has had any prior feedback and ratings (“contact feedback”) awarded by other users/members. The two users are allowed to view member specific and contact specific exchange details.

According to various embodiments, the contractual type document is closed when the exchange is declined, canceled by the member, canceled by a searcher, or marked completed by a member. As used herein, members, searchers, listers, and/or potential customers can all be referred to herein as users. Upon completion, a system can facilitate delivery of goods and services so that a member and searcher never have to meet. Shipping of the items can be automatically handled. According to various embodiments, a shopping cart is also provided for members to allow potential customers to aggregate items for purchase. The purchased items can be exchanged/purchased in person or online. In particular embodiments, the shopping cart allows for gathering of goods from one or more listers.

According to various embodiments, both the member and the searcher send and receive messages through emails that are managed by the Yaplinks mail server. The YapLinks mail server ensures that both the personal email addresses of the member and the searcher are not revealed to either party so that contact information remains protected. Instant messages are also managed by Yaplinks to allow real time messaging using a computer or mobile device. This instant messaging feature will automatically be active if the application senses that both the member and searcher are logged into the ‘Yap’ at the same time. If it does not detect that both parties are logged into the Yap at the same time, the communication exchange will default to the email exchange handled by the Yaplinks mail server. In particular embodiments, even when both parties are logged in at the same time, and using instant messaging to communicate, all communication exchanges/messages are still stored in a database and may be included in a contractual type document.

A variety of servers can be used to implement a secure and enhanced classified listing system. According to particular embodiments, a server suitable for various embodiments of techniques and mechanisms described in this document includes a processor, memory, an interface (input and/or output), and a bus (e.g., a PCI bus or other interconnection fabric) and operates as a listing server. When acting under the control of appropriate software or firmware, the processor is responsible for collecting and processing user response and generating and transmitting reports based on these messages. Various specially configured devices can also be used in place of a processor or in addition to processor. The interface is typically configured to send and receive data packets or data segments over a network.

Because information and program instructions may be employed to implement the systems/methods described herein, the present invention relates to tangible, machine readable media that include program instructions, state information, etc. for performing various operations described herein. Examples of machine-readable media include hard disks, floppy disks, magnetic tape, optical media such as CD-ROM disks and DVDs; magneto-optical media such as optical disks, and hardware devices that are specially configured to store and perform program instructions, such as read-only memory devices (ROM) and programmable read-only memory devices (PROMs). Examples of program instructions include both machine code, such as produced by a compiler, and files containing higher level code that may be executed by the computer using an interpreter.

While the invention has been particularly shown and described with reference to specific embodiments thereof, it will be understood by those skilled in the art that changes in the form and details of the disclosed embodiments may be made without departing from the spirit or scope of the invention. It is therefore intended that the invention be interpreted to include all variations and equivalents that fall within the true spirit and scope of the present invention.

Although the foregoing invention has been described in some detail for purposes of clarity of understanding, it will be apparent that certain changes and modifications may be practiced within the scope of the appended claims. Therefore, the present embodiments are to be considered as illustrative and not restrictive and the invention is not to be limited to the details given herein, but may be modified within the scope and equivalents of the appended claims.

What is claimed is:

1. A method, comprising:
receiving profile information associated with a classified listing user;
maintaining the profile information in a profile datastore;
receiving a plurality of testimonials, recommendations, and feedback for the classified listing user, wherein testimonials are provided by third parties, recommendations are provided by other classified listing users, and feedback is provided by customers of the classified listing user;
associating a first classified listing from the classified listing user with the profile information and the plurality of testimonials, recommendations, and feedback;
generating a physical or electronic business card using the first classified listing.

2. The method of claim 1, wherein a plurality of messages are received from and sent to a potential customer for the first classified listing.

3. The method of claim 2, wherein the plurality of messages include messages formally accepted.

4. The method of claim 3, wherein the plurality of messages are codified into a contractual document which operates to signify acceptance and/or completion of a transaction sequence.

5. The method of claim 1, wherein the first classified listing is converted into a physical or electronic business card.

6. The method of claim 5, wherein the physical or electronic business card includes testimonial, recommendation, and feedback counts.

7. The method of claim 6, wherein the electronic business card includes a link to the first classified listing.

8. The method of claim 1, wherein accepting a first message reveals profile information of the classified listing user from the profile datastore.

9. The method of claim 8, wherein accepting a second message reveals additional profile information of the classified listing user from the profile datastore.

10. The method of claim 1, wherein accepting a first message reveals profile information of a potential customer.

11. An apparatus, comprising:
an interface configured to receive profile information associated with a classified listing user and a plurality of testimonials, recommendations, and feedback for the classified listing user, wherein testimonials are provided by third parties, recommendations are provided by other classified listing users, and feedback is provided by customers of the classified listing user;
a profile datastore configured to maintain the profile information and the plurality of testimonials, recommendations, and feedback; and
a processor configured to associate a first classified listing from the classified listing user with the profile information and the plurality of testimonials, recommendations, and feedback, wherein a physical or electronic business card is generated using the first classified listing.

12. The apparatus of claim 11, wherein a plurality of messages are received from and sent to a potential customer for the first classified listing.

13. The apparatus of claim 12, wherein the plurality of messages include messages formally accepted.

14. The apparatus of claim 13, wherein the plurality of messages are codified into a contractual document which operates to signify acceptance and/or completion of a transaction sequence.

15. The apparatus of claim 11, wherein the first classified listing is converted into a physical or electronic business card.

16. The apparatus of claim 15, wherein the physical or electronic business card includes testimonial, recommendation, and feedback counts.

17. The apparatus of claim 16, wherein the electronic business card includes a link to the first classified listing.

18. The apparatus of claim 11, wherein accepting a first message reveals profile information of the classified listing user from the profile datastore.

19. The apparatus of claim 18, wherein accepting a second message reveals additional profile information of the classified listing user from the profile datastore.

20. A computer readable medium, comprising:
computer code for receiving profile information associated with a classified listing user;
computer code for maintaining the profile information in a profile datastore;
computer code for receiving a plurality of testimonials, recommendations, and feedback for the classified listing user, wherein testimonials are provided by third parties, recommendations are provided by other classified listing users, and feedback is provided by customers of the classified listing user;
computer code for associating a first classified listing from the classified listing user with the profile information and the plurality of testimonials, recommendations, and feedback.
computer code for generating a physical or electronic business card using the first classified listing.
